(19) United States
(12) Patent Application Publication
(10) Pub. No.: US 2023/0306283 A1
(43) Pub. Date: Sep. 28, 2023

(54) DEVICE AND METHOD FOR TRAINING A MODEL FOR LINKING A MENTION TO AN ENTITY ACROSS KNOWLEDGE BASES

(71) Applicant: Robert Bosch GmbH, Stuttgart (DE)

(72) Inventors: Hassan Soliman, Saarbrücken (DE); Dragan Milchevski, Leonberg (DE); Heike Adel-Vu, Renningen (DE); Mohamed Gad-Elrab, Saarbruecken (DE); Jannik Stroetgen, Karlsruhe (DE)

(21) Appl. No.: 18/178,373

(22) Filed: Mar. 3, 2023

(30) Foreign Application Priority Data
Mar. 25, 2022 (DE) 10 2022 202 983.6

(51) Int. Cl. G06N 5/022

(52) U.S. Cl. CPC G06N 5/022

(57) ABSTRACT

A device and method for training a model for linking a mention in textual context to an entity across knowledge bases. I the method, depending on training data, training the model for mapping an entity of a first knowledge base to its first representation in a vector space, for mapping an entity of a second knowledge base to its second representation in the vector space, for mapping the mention to a third representation in the vector space. The training data includes a set of pairs in which each pair includes a mention in a textual context and its corresponding reference entity in either the first knowledge base or the second knowledge base. Training the model includes evaluating a loss function.

### CROSS REFERENCE

The present application claims the benefit under 35 U.S.C. § 119 of German Patent Application No. DE 10 2022 202 983.6 filed on Mar. 25, 2022, which is expressly incorporated herein by reference in its entirety.

### FIELD

The present invention relates to a device and a method for training a model for linking a mention to an entity across knowledge bases.

### BACKGROUND INFORMATION

In entity linking, mentions are typically linked against one background knowledge graph from a particular domain. State-of-the-art approaches addressing multiple domains treat the problem of linking against another knowledge graph as zero-shot learning.

Ledell Wu, Fabio Petroni, Martin Josifoski, Sebastian Riedel, and Luke Zettlemoyer; “Scalable zero-shot entity linking with dense entity retrieval;” in Bonnie Webber, Trevor Cohn, Yulan He, and Yang Liu, editors, Proceedings of the 2020 Conference on Empirical Methods in Natural Language Processing, EMNLP 2020, Online, Nov. 16-20, 2020, pages 6397-6407; Association for Computational Linguistics, 2020. doi: 10.18653/v1/ 2020.emnlp-main. 519 describes one state-of-the-art approach.

However, for this approach, a user or a machine needs to decide against which knowledge graph the mentions should be linked, i.e., know the domain of interest. Given a new text, this can be arguably challenging or require a lot of time and computing resources.

### SUMMARY

A method, a device and a computer program according to the present invention may improve entity linking in particular for large scale problems, where there are many, in particular millions, of possible entities to consider for each mention.

According to an example embodiment of the present invention, the method for training a model for linking a mention in textual context to an entity across knowledge bases comprises, depending on training data, training the model for mapping an entity of a first knowledge base to its first representation in a vector space, for mapping an entity of a second knowledge base to its second representation in the vector space, for mapping the mention to a third representation in the vector space, wherein the training data comprises a set of pairs in which each pair comprises a mention in a textual context and its corresponding reference entity in either the first knowledge base or the second knowledge base, wherein training the model comprises evaluating a loss function, wherein the loss function comprises for each pair a measure of a similarity between a representation in the vector space of the mention in the pair and a representation in the vector space of the reference entity in the pair, and/or a measure of a dissimilarity between a representation in the vector space of the mention in the pair and at least one representation in the vector space of an entity of the first knowledge base or the second knowledge base, that is different than the reference entity in the pair, wherein the training data comprises a set of pairs in which each pair comprises an entity of the first knowledge base and an entity of the second knowledge base, wherein the entities in the pair are the same and a set of pairs in which each pair comprises an entity of the first knowledge base and an entity of the second knowledge base, wherein the entities in the pair differ from each other or are dissimilar or are not the same, wherein the loss function comprises a measure of a similarity between the representations in the vector space of the entities in the pair and/or a measure of a dissimilarity between the representations in the vector space of the entities in the pair. The model is trained to link the mention in the vector space to one of many possible entities from two different knowledge bases. The knowledge base is for example a knowledge graph. The trained model resulting from this training is able to process directly the entity of the first knowledge base and/or the second knowledge base. The model learns to map entities that are similar to the mention, to representations that are closer to the representation of the mention than entities that are dissimilar to the mention. The model learns to map entities that correspond to each other or are similar to each other or are the same to representations that are closer to each other than representations of the entities that differ from each other or that are dissimilar to each other or that are not the same.

According to an example embodiment of the present invention, the method may comprise providing, in the vector space, a set of representations, wherein the set comprises first representations that each represent one entity of the first knowledge base, wherein the set comprises second representations that each represent one entity of the second knowledge base, wherein the method further comprises providing the third representation in the vector space that represents the mention, selecting a subset of the set of representations, wherein the subset comprises at least one first representation and/or at least one second representation that is more similar to the third representation than other representations of the set of representations, linking the mention to the entity that is represented by a representation that is selected from the subset. With the method, the mention is linked to one entity of one of these graphs in a single step.

According to an example embodiment of the present invention, selecting the subset may comprise selecting at least two representations that are more similar to the third representation than other representations, determining a score for the at least two representations, wherein the score for each representation of the at least two representations is determined depending on the mention and the entity that it represents, wherein selecting the representation that is more similar to the third representations from the subset comprises ranking the at least two representations depending on their score and selecting the representation that has the higher score. The subset comprises representations of entities that are candidates to which the mention, may be linked. The score indicates which of the entities the best candidate is. The subset may comprise entities from the first knowledge base, the second knowledge base or from both. Thus, the best candidate from both knowledge bases is selected in a single step.

According to an example embodiment of the present invention, selecting the subset may comprise selecting in particular a given amount of the representations that are closer to the third representation than other representations or representations that are within a given distance from the third representation. This influences the size of the subset and allows controlling the computing resources that are required for processing.

According to an example embodiment of the present invention, providing the set of representations may comprise mapping at least one entity of the first knowledge base with the trained model to its first representation and/or mapping at least one entity of the second knowledge base with the trained model to its second representation.

The method according to an example embodiment of the present invention may comprise mapping the mention with the trained model to the third representation.

According to an example embodiment of the present invention, evaluating the measure of similarity and/or the measure of dissimilarity may comprise determining a distance between the representations in the pair in the vector space.

According to an example embodiment of the present invention, the device for training a model for linking a mention to an entity of a first knowledge base or of a second knowledge base is adapted to execute the method. This device achieves the advantages of the method disclosed herein.

According to an example embodiment of the present invention, the device may comprise at least one processor and at least one storage for storing instructions, that when executed by the at least one processor cause the device to execute the method.

Accordig to an example embodiment of the rpesnet invention, the computer program comprises computer-readable instructions that, when executed by a computer, cause the computer to execute the method disclosed herein.

Further embodiments of the present invention are derived from the following description and the figures.

### BRIEF DESCRIPTION OF THE DRAWINGS

FIG. 1 schematically depicts a device for linking a mention to an entity, according to an example embodiment of the present invention.

FIG. 2 schematically depicts a vector space, according to an example embodiment of the present invention.

FIG. 3 depicts a flow chart with steps in a method for linking the mention to the entity, according to an example embodiment fo the present invention.

### DETAILED DESCRIPTION OF EXAMPLE EMBODIMENTS

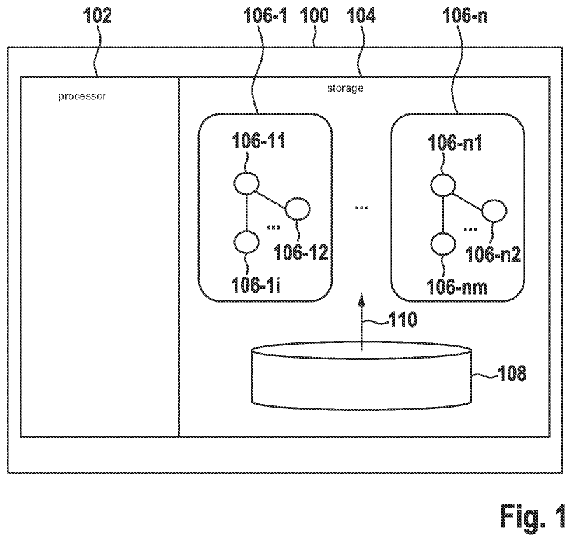

FIG. 1 schematically depicts a device 100. The device 100 comprises at least one processor 102 and at least one storage 104.

The at least one storage 104 is in the example adapted to store at least two knowledge bases.

In FIG. 1, a first knowledge base 106-1 and a second knowledge base 106-n are depicted. There may be more knowledge bases stored. In the example, the knowledge bases are knowledge graphs.

The knowledge bases comprise entities. In FIG. 1, first entities 106-11, . . . , 106-1i of the first knowledge base 106-1 and second entities 106-n1, . . . , 106-nm of the second knowledge base 106-n are depicted.

The first knowledge base 106-1 in some embodiments comprises at least i=100 first entities 106-11, . . . , 106-1i. The second knowledge base 106-n in some embodiments comprises at least m=100 second entities 106-11, . . . , 106-1m.

The first knowledge base 106-1 in some further embodiments comprises at least i=1000 first entities 106-11, . . . , 106-1i. The second knowledge base 106-n in some further embodiments comprises at least m=1000 second entities 106-11, . . . , 106-1m.

The first knowledge base 106-1 in some further embodiments comprises at least i=10000 first entities 106-11, . . . , 106-1i. The second knowledge base 106-n in some further embodiments comprises at least m=10000 second entities 106-11, . . . , 106-1m.

In some embodiments, at least one knowledge base comprises at least 100 entites. In some further embodiments, at least one knowledge base comprises at least 1000 entites. In some embodiments, at least one knowledge base comprises at least 10000 entites.

In the example, the knowledge bases relate entities of the same knowledge base pairwise with each other. The knowledge bases in some embodiments comprise at least 100 relations. The knowledge bases in some embodiments comprise at least 1000 relations. The knowledge bases in some embodiments comprise at least 10000 relations.

In a knowledge graph the entities are arranged as vertices and relations are arranged as edges in a graph structure. In some embodiments, in at least one knowledge graph an amount of vertices exceeds 100 and an amount of edges exceeds 100. In some further embodiments, in at least one knowledge graph an amount of vertices exceeds 1000 and an amount of edges exceeds 1000. In some further embodiments, in at least one knowledge graph an amount of vertices exceeds 10000 and an amount of edges exceeds 10000.

The storage 104 is in the example adapted to store a source 108 of a mention 110. The source 108 may comprise a text. The mention 110 may be a mention in textual context, e.g. in the text.

The device 100 is adapted for linking the mention 110 to one entity 106-11, . . . , 106-nm of either the first knowledge base 106-1 or of the second knowledge base 106-n. In case more than two knowledge bases are available, the device 100 is adapted to link the mention 110 to one entity of one of the more than two knowledge bases. Preferably, the device 100 is adapted for linking the mention 110 to one entity of at least 10 knowledge bases. More preferably, the device is adapted for linking the mention 110 to one enity of at least 100 knowledge bases.

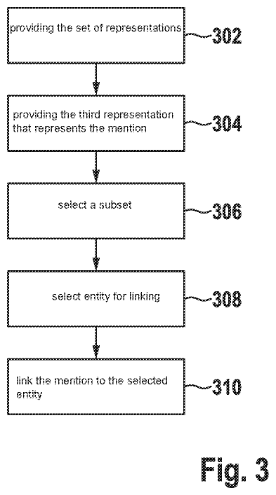

The at least one storage 104 may be adapted for storing instructions, that when executed by the at least one processor 102, cause the at least one processor 102 to execute steps in a method that is described below with reference to FIG. 3.

A computer program may comprise computer-readable instructions that, when executed by a computer, e.g. the device 100, cause the computer to execute the method.

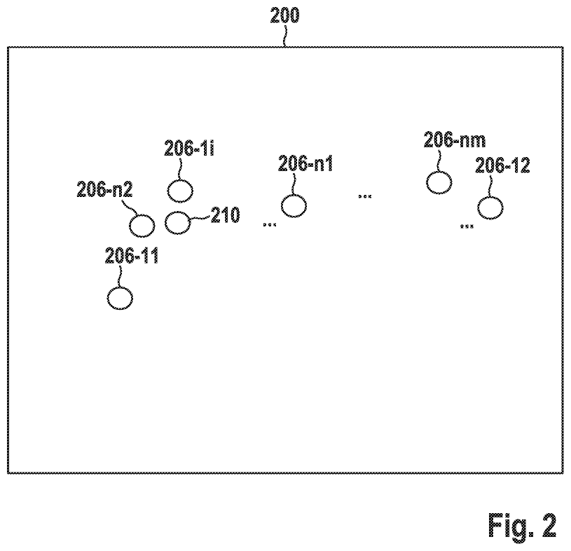

FIG. 2 depicts schematically a vector space 200. The vector space 200 comprises a set of representations 206-11, . . . , 206-nm. The set comprises first representations 206-11, . . . , 206-1i that each represent one entity 106-11, . . . , 106-1i of the first knowledge base 106-1. The set comprises second representations 206-n1, . . . , 206-nm that each represent one entity 106-n1, 106-nm of the second knowledge base 106-n.

The vector space 200 comprises a third representation 210 of the mention 110.

The representations are in the example vectors in the vector space 200. For more than two knowledge bases, the vector space 200 comprises representations of the entities of the more than two knowledge bases.

With the method, mentions are linked against several knowledge graphs at the same time. Those knowledge graphs can be from different domains.

In one example, the first knowledge graph 106-1 is from a general domain like Wikipedia and the second knowledge graph 106-n is domain-specific, like MITRE ATT&CK for a cyber-security domain.

Thus, in case the text comprises both mentions from the general domain and domain-specific mentions, the mention 110 is linked to one entity, without the need of manually selecting in advance from which of the knowledge graphs the entity is. In addition, the method saves training time and resources. It only requires fine-tuning a general-domain model using the domain-specific data.

This will be explained for automatic knowledge graph population. In automatic knowledge graph population, entity linking is an important task. The goal of entity linking is to find the correct entity for the mention in the text.

For example, the mention might refer to different persons depending on the textual context. Entity linking resolves this ambiguity taking into account the textual context as well as information from the knowledge graphs containing candidate entities.

Specific challenges arise with different domains: the textual data as well as the entities mentioned in them can be from different domains. For example, a certain hacker group might occur as an entity in the knowledge graph MITRE ATT&CK but not in Wikipedia while a more general concept like a brand name of a car might occur in Wikipedia but not in MITRE ATT&CK. Thus, if a sentence in the text contains both the hacker group and the car, not all mentions can be linked to entities when considering only one of these knowledge graphs at the same time.

The method described below can be used in an entity linking system that comprises a candidate generation module and a candidate ranking module. An example for these is described in Ledell Wu, Fabio Petroni, Martin Josifoski, Sebastian Riedel, and Luke Zettlemoyer; “Scalable zero-shot entity linking with dense entity retrieval;” in Bonnie Webber, Trevor Cohn, Yulan He, and Yang Liu, editors, Proceedings of the 2020 Conference on Empirical Methods in Natural Language Processing, EMNLP 2020, Online, Nov. 16-20, 2020, pages 6397-6407. Association for Computational Linguistics, 2020. doi: 10.18653/v1/2020.emnlp-main. 519. The candidate generation module for example represents both the candidate entities 106-11, . . . , 106-nm from the knowledge graphs 106-1, . . . , 106-n and the mention 110, e.g. the mention, as the vectors in the vector space 200.

The candidate generation module may comprise a candidate encoder for mapping a candidate entity 106-11, . . . , 106-nm to its corresponding first or second representation 206-11, . . . , 206-nm. The candidate encoder may comprise a context encoder for mapping the mention 110 to its corresponding third representation 210.

The candidate generation module may be adapted to assess their similarity to find the closest entities for the mention.

The candidate ranking module may comprise a cross-encoder to assess a pairwise similarity between each candidate entity 106-11, . . . , 106-nm and the mention 110. The candidate ranking module may output the candidate entity 106-11, . . . , 106-nm with the highest similarity score.

The candidate generation module in the example is a model. The model in the example is the general-domain model. The model is fine-tuned with a loss function that is described below.

FIG. 3 depicts a flow chart with steps of the method for linking the mention 110 to one entity of either the first knowledge base 106-1 or of the second knowledge base 106-n. In case more than two knowledge bases are available, the method is executed alike, considering the more than two knowledge bases at the same time.

The method comprises a step 302.

The step 302 comprises providing, in the vector space 200, the set of representations 206-11, . . . , 206-nm.

The set comprises the first representations 206-11, . . . , 206-1i that each represent one entity 106-11, . . . , 106-1i of the first knowledge base 106-1.

The set comprises the second representations 206-n1, . . . , 206-nm that each represent one entity 106-n1, . . . , 106-nm of the second knowledge base 106-n.

Providing the set of representations in the vector space 200 may comprise training the model. The model may be pre-trained before the method executes.

The model is in one example trained for mapping an entity of the first knowledge base 106-1 to its first representation in the vector space 200.

The method comprises mapping at least one entity of the first knowledge base 106-1 with the trained model to its first representation.

The model is in one example fine-tuned for mapping an entity of the second knowledge base 106-n to its second representation in the vector space 200. This means, the model ist trained for mapping to the first knowledge base 106-1 and fine-tuned so that it can afterwards map to both the first knowledge base 106-1 and the second knowledge base 106-n.

The method comprises mapping at least one entity of the second knowledge base 106-n with the trained model to its second representation.

For more than two knowledge graphs, the model may be trained or fine-tuned accordingly and their entities may be mapped alike to their representations in the vector space 200.

Training the model may comprise training or pre-training the model for mapping the mention 110 to the third representation 210.

The method comprises mapping the mention 110 with the trained model to the third representation 210.

In one example, the model is trained depending on training data.

The training data comprises a set of pairs in which each pair comprises a mention and an entity of either the first knowledge base or the second knowledge base.

For more than two knowledge graphs, the training data may comprise pairs of the mention and an entity from one of these knowledge graphs as well.

Training the model in the example comprises evaluating a loss function.

The loss function may comprise a measure of a similarity between the representation of the mention and the representation of the entity in the pair.

The loss function may comprise a measure of a dissimilarity between the representation in the vector space mention in the pair and at least one representation in the vector space of an entity of the first knowledge base or the second knowledge base that is different than the entity in the pair.

The training data may comprise a set of pairs in which each pair comprises an entity of the first knowledge base and an entity of the second knowledge base.

For more than two knowledge graphs, the training data may comprise pairs of entities that are from different of the knowledge graphs.

The entities in the pair in one example shall be the same. In this case, training the model comprises evaluating a measure of a similarity between the representations in the vector space of the entities in the pair. The loss function may comprise this measure. The pairs are for example determined so that representations in the vector space of the entities that shall be linked by the trained model to the same mention are closer to each other in the vector space than representations of other entities that shall not be linked to this mention by the trained model.

The entities in the pair in one example differ from each other or are dissimilar or are not the same. In this case, training the model comprises evaluating a measure of a dissimilarity between the representations in the vector space of the entities in the pair. The loss function may comprise this measure. The pairs are for example determined so that representations in the vector space of the entities that shall not be linked by the trained model to the same mention are farther away from each other in the vector space than representations of other entities that shall be linked to this mention by the trained model.

An exemplary loss function for training data T considering these measures is given as

$${L}_{θ} = {\sum }_{m , r ∈ T} ( - {v}_{m}^{T} {v}_{r} + log {\sum }_{e ∈ {C}_{e}} exp ( {v}_{m}^{T} {v}_{e} ) ) + {\sum }_{{o}_{1} , {o}_{2} ∈ O} ( - {v}_{{o}_{1}}^{T} {v}_{{o}_{2}} + log {\sum }_{p ∈ {C}_{p}} exp ( {v}_{{o}_{1}}^{T} {v}_{p} ) + log {\sum }_{q ∈ {C}_{q}} exp ( {v}_{{o}_{2}}^{T} {v}_{q} ) )$$

wherein θ are parameters of the model, o₁,o₂∈0 are entities in a set of overlapping entities 0 from different knowledge graphs that shall be the same, wherein vₘ is the third representation 210 representing the mention 110, vᵣ is the representation of the entity of one of the knowledge graphs that is linked to the mention 110 according to a training data pair, vₑ is a negative example, i.e. an entity of a set of candidate entities Cₑ that is different from the mention 110 according to a training data pair, vₒ_{₁} is a first entity in a pair of overlapping entities, vₒ_{₂} is a second entity in the pair of overlapping entities, vₚ,v_{q} are entity representations from entities of sets Cₚ and C_{q} that do not overlap with entities o₁,o₂.

This means, evaluating the measure of similarity and/or the measure of dissimilarity comprises determining a distance between the representations in pairs of representations in the vector space.

According to an example, the parameters θ of the model are trained with training data from the general domain and then fine-tuned with the loss function L_{θ}. The loss function L_{θ} ensures that
(1) the representation 210 for the mention 110, e.g. the mention from the text, and the representation of the correct entity from one of the knowledge graphs are close together. This is achieved with a first dot product —vₘ^{T}vᵣ
(2) the representation for the mention mention and the other, i.e. wrong, candidate entities from the set of candidate entities Cₑ are further apart. This is achieved with a second dot product vₘ^{T}vₑ
(3) entities that occur in both knowledge graphs, i.e. overlapping entities, get similar representations. This is achieved with a third dot product —vₒ_{₁}^{T}vₒ_{₂}
(4) the representation for an overlapping entity and the other entities that do not overlap, i.e. entities from the sets Cₚ and C_{q}, are further apart. This is achieved with a forth dot product vₒ_{₁}^{T}vₚ and a fifth dot product vₒ_{₂}^{T}v_{q}.

Afterwards, a step 304 is executed.

In the step 304, the method further comprises providing the third representation 210 in the vector space 200 that represents the mention 110.

Afterwards a step 306 is executed.

The step 306 comprises selecting a subset of the set of representations 206-11, . . . , 206-nm.

The subset comprises at least one first representation and/or at least one second representation that is more similar to the third representation 210 than other representations of the set of representations. In the example depicted in FIG. 2, the subset comprises the representation 206-1i and 206-n2 but not the representations 206-11, 206-12, 206-n1, 206-nm. For more than two knowledge bases, the subset may comprise entities from any of these.

Selecting the subset may comprise selecting at least two representations that are more similar to the third representation 210 than other representations.

Selecting the subset according to one example comprises selecting representations that are closer to the representation of the third representation 210 than other representations in the vector space 200. In one example a given amount of the representations is selected.

Selecting the subset according to one example comprises selecting representations in the vector space 200 that are within a given distance from the third representation 210.

Afterwards a step 308 is executed.

The step 308 comprises selecting the entity for linking. Selecting the entity for linking in the example comprises selecting a representation from the subset.

Selecting the entity for linking may comprise determining a score for the representations. In one example. The score that is determined for a given entity is determined depending on the representation of the mention 110 and the representation of this entity.

Selecting the entity for linking may comprise ranking the representations depending on their score.

In one example, the representation with the highest score is selected.

In one example, the representation that has a higher score than at least one other representation is selected.

In the example the entity that is selected is either from the first knowledge base 106-1 or from the second knowledge base 106-n. For more than two knowledge bases, the entity may be from any of these.

Afterwards a step 310 is executed.

The step 310 comprises linking the mention 110 to the entity that is represented by the representation that is selected from the subset.

In one example, the training comprises the following steps:
1. train the candidate generation module on the general domain.

Training the candidate generation module, e.g. the corresponding model, may be implemented e.g. as described in “Scalable zero-shot entity linking with dense entity retrieval.”
2. fine-tune the candidate generation module using the loss function L_{θ} and the following training data:
Domain-specific data: For example, the zero-shot entity linking dataset (Zeshel) from Fandom: Lajanugen Logeswaran, Ming-Wei Chang, Kenton Lee, Kristina Toutanova, Jacob Devlin, and Honglak Lee; “Zero-shot entity linking by reading entity descriptions;” in Anna Korhonen, David R. Traum, and Llu is Marquez, editors, Proceedings of the 57th Conference of the Association for Computational Linguistics, ACL 2019, Florence, Italy, Jul. 28-Aug. 2, 2019, Volume 1: Long Papers, pages 3449-3460. Association for Computational Linguistics, 2019. doi: 10.18653/v1/p19-1335. Any other domain-specific data set may be used as well.

This data contains multiple domains. For each domain, there are entities with textual descriptions and labeled mentions extracted from articles about that domain.
General-domain augmentation data: For example, the Reddit mentions dataset: Nicholas Botzer, Yifan Ding, and Tim Weninger; “Reddit entity linking dataset;” Inf. Process. Manag., 58(3):102479, 2021. doi: 10.1016/j.ipm.2020.102479. Any other general-domain data set may be used as well.

This data comprises mentions that are extracted from Reddit posts and comments by Reddit users and annotated on Wikipedia entities.
List of overlapping entities: For example, this list is generated by string matching of entity names that occur in the two or more knowledge bases or by using a more sophisticated model, such as a sentence transformer to get semantic similarities between entities from the two or more knowledge bases and defining a threshold for the similarity which is used to determine whether two entities should be considered as overlapping or not. The sentence transformer may be Sentence-BERT as described in Nils Reimers and Iryna Gurevych. 2019; “Sentence-BERT: Sentence Embeddings using Siamese BERT-Networks;” in Proceedings of the 2019 Conference on Empirical Methods in Natural Language Processing and the 9th International Joint Conference on Natural Language Processing (EMNLP-IJCNLP), pages 3982-3992, Hong Kong, China. Association for Computational Linguistics.
3. train the candidate ranking module, e.g. the corresponding model, on the general domain e.g. as described in “Scalable zero-shot entity linking with dense entity retrieval.”

What is claimed is:

1. A method for training a model for linking a mention in textual context to an entity across knowledge bases, the method comprising the following steps:
training, depending on training data, the model for mapping an entity of a first knowledge base to its first representation in a vector space, for mapping an entity of a second knowledge base to its second representation in the vector space, and for mapping the mention to a third representation in the vector space;
wherein the training data includes a set of pairs in which each of the set of pairs includes a mention in a textual context and a corresponding reference entity in either the first knowledge base or the second knowledge base;
wherein training the model includes evaluating a loss function, the loss function including, for each pair of the set of pairs, (i) a measure of a similarity between a representation in the vector space of the mention in the pair and a representation in the vector space of the reference entity in the pair, and/or (ii) a measure of a dissimilarity between a representation in the vector space of the mention in the pair and at least one representation in the vector space of an entity of the first knowledge base or the second knowledge base, that is different than the reference entity in the pair;
wherein the training data includes a set of pairs in which each pair includes an entity of the first knowledge base and an entity of the second knowledge base, wherein the entities of the first and second knowledge bases in the pair are the same, and a set of pairs in which each pair includes an entity of the first knowledge base and an entity of the second knowledge base, wherein the entities of the first and second knowledge base in the pair differ from each other or are dissimilar or are not the same; and
wherein the loss function includes a measure of a similarity between the representations in the vector space of the entities of the first and second knowledge bases in the pair and/or a measure of a dissimilarity between the representations in the vector space of the entities of the first and second knowledge bases in the pair.

2. The method according to claim 1, further comprising:
providing, in the vector space, a set of representations, wherein the set of represetations includes first representations that each represent one entity of the first knowledge base, and wherein the set of representations further includes second representations that each represent one entity of the second knowledge base;
and wherein the method further comprises:
providing the third representation in the vector space that represents the mention;
selecting a subset of the set of representations,
wherein the subset of the set of represetnations includes at least one first representation and/or at least one second representation that is more similar to the third representation than other representations of the set of representations;
linking the mention to the entity that is represented by a representation that is selected from the subset.

3. The method according to claim 2, wherein the selecting of the subset includes selecting at least two representations that are more similar to the third representation than other representations, and determining a score for the at least two representations, wherein the score for each representation of the at least two representations is determined depending on the mention and the entity that it represents, and wherein the selecting of the representation that is more similar to the third representations from the subset includes ranking the at least two representations depending on their score and selecting the representation that has a higher score.

4. The method according to claim 2, wherein the selecting of the subset includes selecting in particular a given amount of the representations that are closer to the third representation than other representations or representations that are within a given distance from the third representation.

5. The method according to claim 2, wherein the providing of the set of representations includes mapping at least one entity of the first knowledge base with the trained model to its first representation and/or mapping at least one entity of the second knowledge base with the trained model to its second representation.

6. The method according to claim 1, further comprising mapping the mention with the trained model to the third representation.

7. The method according to claim 1, wherein the the evaluating of the measure of similarity and/or the measure of dissimilarity includes determining a distance between the representations in the pair in the vector space.

8. A device for training a model for linking a mention in textual context to an entity across knowledge bases, the device configured to:
train, depending on training data, the model for mapping an entity of a first knowledge base to its first representation in a vector space, for mapping an entity of a second knowledge base to its second representation in the vector space, and for mapping the mention to a third representation in the vector space;
wherein the training data includes a set of pairs in which each of the set of pairs includes a mention in a textual context and a corresponding reference entity in either the first knowledge base or the second knowledge base;
wherein training the model includes evaluating a loss function, the loss function including, for each pair of the set of pairs, (i) a measure of a similarity between a representation in the vector space of the mention in the pair and a representation in the vector space of the reference entity in the pair, and/or (ii) a measure of a dissimilarity between a representation in the vector space of the mention in the pair and at least one representation in the vector space of an entity of the first knowledge base or the second knowledge base, that is different than the reference entity in the pair;
wherein the training data includes a set of pairs in which each pair includes an entity of the first knowledge base and an entity of the second knowledge base, wherein the entities of the first and second knowledge bases in the pair are the same, and a set of pairs in which each pair includes an entity of the first knowledge base and an entity of the second knowledge base, wherein the entities of the first and second knowledge base in the pair differ from each other or are dissimilar or are not the same; and
wherein the loss function includes a measure of a similarity between the representations in the vector space of the entities of the first and second knowledge bases in the pair and/or a measure of a dissimilarity between the representations in the vector space of the entities of the first and second knowledge bases in the pair.

9. The device according to claim 8, wherein the device comprises:
at least one processor; and
at least one storage configured to store instructions, that when executed by the at least one processor to train the model.

10. A non-transitory computer-readable medium on which is stored a computer program for training a model for linking a mention in textual context to an entity across knowledge bases, the computer program, when executed by at least one processor, causing the at least one processor to perform the following steps:
training, depending on training data, the model for mapping an entity of a first knowledge base to its first representation in a vector space, for mapping an entity of a second knowledge base to its second representation in the vector space, and for mapping the mention to a third representation in the vector space;
wherein the training data includes a set of pairs in which each of the set of pairs includes a mention in a textual context and a corresponding reference entity in either the first knowledge base or the second knowledge base;
wherein training the model includes evaluating a loss function, the loss function including, for each pair of the set of pairs, (i) a measure of a similarity between a representation in the vector space of the mention in the pair and a representation in the vector space of the reference entity in the pair, and/or (ii) a measure of a dissimilarity between a representation in the vector space of the mention in the pair and at least one representation in the vector space of an entity of the first knowledge base or the second knowledge base, that is different than the reference entity in the pair;
wherein the training data includes a set of pairs in which each pair includes an entity of the first knowledge base and an entity of the second knowledge base, wherein the entities of the first and second knowledge bases in the pair are the same, and a set of pairs in which each pair includes an entity of the first knowledge base and an entity of the second knowledge base, wherein the entities of the first and second knowledge base in the pair differ from each other or are dissimilar or are not the same; and
wherein the loss function includes a measure of a similarity between the representations in the vector space of the entities of the first and second knowledge bases in the pair and/or a measure of a dissimilarity between the representations in the vector space of the entities of the first and second knowledge bases in the pair.
